(19) United States
(12) Patent Application Publication
(10) Pub. No.: US 2026/0138601 A1
(43) Pub. Date: May 21, 2026

(54) ROADWAY DEPARTURE AVOIDANCE DEVICE, ROADWAY DEPARTURE AVOIDANCE METHOD, AND STORAGE MEDIUM

(71) Applicant: TOYOTA JIDOSHA KABUSHIKI KAISHA, Toyota-shi (JP)

(72) Inventor: Hikaru AKIMOTO, Mishima-shi (JP)

(73) Assignee: TOYOTA JIDOSHA KABUSHIKI KAISHA, Toyota-shi (JP)

(21) Appl. No.: 19/298,621

(22) Filed: Aug. 13, 2025

(30) Foreign Application Priority Data
Nov. 20, 2024 (JP) 2024-201992

(51) Int. Cl. B60W 30/12

(52) U.S. Cl. CPC B60W 30/12; B60W 2520/10; B60W 2520/125; B60W 2540/12; B60W 2552/30; B60W 2720/24

(57) ABSTRACT

A driving assistance ECU performs a roadway departure avoidance operation by applying, to a vehicle, a force for changing a traveling direction of the vehicle so that the vehicle does not deviate from a traveling lane in which the vehicle is traveling, when a predetermined start condition is satisfied, the predetermined start condition being satisfied in a case where there is a possibility that the vehicle deviates from the traveling lane. The driving assistance ECU is configured to perform at least one of: first processing of changing the start condition to a condition that is more easily satisfied compared to when the specific condition is not satisfied; and second processing of increasing, at a time point immediately after the start condition is satisfied, the force for changing the traveling direction of the vehicle, compared to when the specific condition is not satisfied when the specific condition is satisfied.

### CROSS-REFERENCE TO RELATED APPLICATION

This application claims priority to Japanese Patent Application No. 2024-201992 filed on Nov. 20, 2024. The disclosure of the above-identified application, including the specification, drawings, and claims, is incorporated by reference herein in its entirety.

### BACKGROUND

### 1. Technical Field

The present disclosure relates to a roadway departure avoidance device, a roadway departure avoidance method, and a storage medium that perform a roadway departure avoidance operation of applying, to the vehicle, a force to change a traveling direction of the vehicle such that the vehicle does not depart from a traveling lane on which the vehicle is traveling.

### 2. Description of Related Art

One roadway departure avoidance device in the related art (hereinafter, simply referred to as “the device in the related art”) changes a control permission range for determining whether to execute a departure avoidance operation solely based on a curvature of a traveling lane (for example, refer to Japanese Unexamined Patent Application Publication No. 2021-30990 (JP 2021-30990 A)).

### SUMMARY

Meanwhile, the device in the related art changes the control permission range in accordance with the curvature of the traveling lane regardless of a vehicle speed when the vehicle enters from a straight road into a curved road. Therefore, for example, a roadway departure avoidance operation may be executed even in a case where a driver has sufficiently reduced the vehicle speed in preparation for the entrance into the curved road. In this case, there is a problem that the driver of the vehicle feels the roadway departure avoidance operation as being troublesome.

The present disclosure has been made in order to address the above-described problems. One object of the present disclosure is to provide a roadway departure avoidance device, a roadway departure avoidance method, and a storage medium as follows. With the roadway departure avoidance device, the roadway departure avoidance method, and the storage medium, it is possible to avoid departure of a vehicle from a traveling lane that is a curved road when the vehicle enters from a straight road into a curved road, and it is possible to reduce a frequency with which a driver of the vehicle feels a roadway departure avoidance operation as being troublesome.

One aspect of a roadway departure avoidance device of the present disclosure includes a controller (10) configured to perform, when a start condition that is predetermined is satisfied (S520: YES), the start condition being satisfied in a case where there is a possibility that a vehicle (HV) departs from a traveling lane (HL) on which the vehicle is traveling, a roadway departure avoidance operation (S570, S580) of applying, to the vehicle, a force to change a traveling direction of the vehicle such that the vehicle does not depart from the traveling lane.

Further, the controller is configured to perform, in a case where a specific condition is satisfied (refer to determinations “YES” in S420, S425, S450, S455), the specific condition including, as one of satisfaction conditions, a first condition in which a vehicle speed when the vehicle enters from a straight road into a curved road is higher than a predetermined vehicle speed threshold value, at least one of first processing (S460, S465, S520) of changing the start condition to a condition that is more easily satisfied as compared with a case where the specific condition is not satisfied, and second processing (S610, S615, S570) of increasing, at a timing immediately after the start condition is satisfied, the force that is applied to the vehicle through the roadway departure avoidance operation to change the traveling direction of the vehicle, as compared with a case where the specific condition is not satisfied.

According to this, when the specific condition is satisfied, the specific condition including, as one of the satisfaction conditions, the first condition in which the vehicle speed when the vehicle enters from the straight road into the curved road is higher than the predetermined vehicle speed threshold value, at least one of the first processing and the second processing is performed.

In a case where the first processing is performed, the roadway departure avoidance operation is executed at an earlier timing. Therefore, the vehicle that travels on the curved road is less likely to depart from the traveling lane. In a case where the second processing is performed, the traveling direction of the vehicle is more quickly changed through the roadway departure avoidance operation. Therefore, the vehicle that travels on the curved road is less likely to depart from the traveling lane.

In addition, both the first processing and the second processing are performed in a case where the vehicle speed when the vehicle enters from the straight road into the curved road is higher than the predetermined vehicle speed threshold value. As a result, in a case where the driver sufficiently reduces the vehicle speed in preparation for the entrance into the curved road, the roadway departure avoidance operation is less likely to be performed, or even when the roadway departure avoidance operation is performed, the traveling direction of the vehicle is not rapidly changed. Therefore, a frequency with which the driver of the vehicle feels the roadway departure avoidance operation as being troublesome can be reduced.

In the above description, for the sake of understanding the present disclosure, names and/or reference numerals used in embodiments described below are shown in parentheses next to a configuration of the disclosure corresponding to the embodiments. However, each component of the present disclosure is not limited to the embodiments defined by the names and/or reference numerals.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a roadway departure avoidance device according to a first embodiment of the present disclosure;

FIG. 2 is a plan view of a traveling lane and a vehicle for describing an operation of the first embodiment;

FIG. 3 is a plan view of a traveling lane and a vehicle for describing an operation of the first embodiment;

FIG. 4 is a flowchart showing a routine executed by a CPU of a driving assistance ECU shown in FIG. 1;

FIG. 5 is a flowchart showing a routine executed by the CPU of the driving assistance ECU shown in FIG. 1; and

FIG. 6 is a flowchart showing a routine executed by a CPU of a roadway departure avoidance device according to a second embodiment of the present disclosure.

### DETAILED DESCRIPTION OF EMBODIMENTS

### 1. First Embodiment

### Configuration

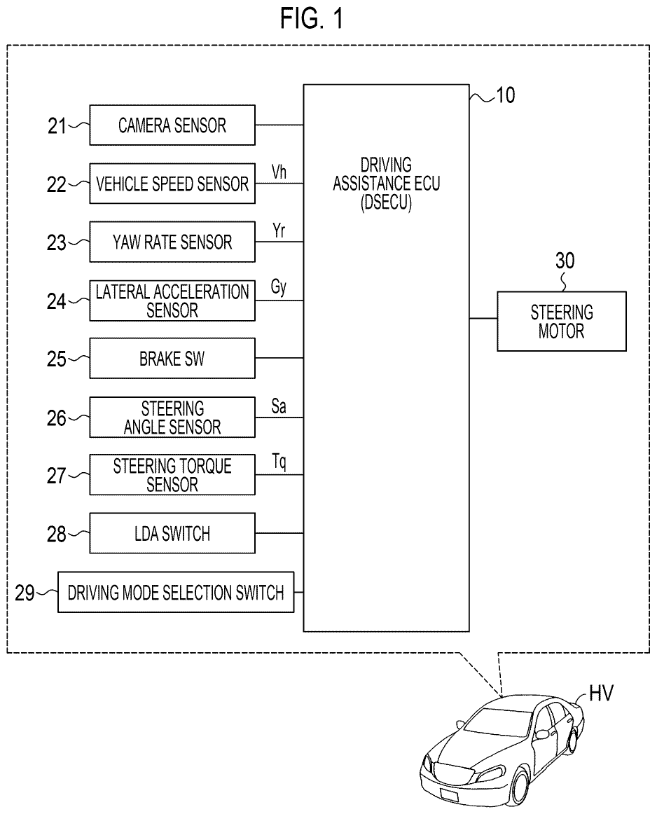

A roadway departure avoidance device according to a first embodiment of the present disclosure (hereinafter, referred to as a “first device DS1”) includes components shown in FIG. 1. The first device DS1 is applied (mounted) to a vehicle HV. The vehicle HV may be any of a vehicle having an internal combustion engine as a power source, a vehicle having an electric motor as a power source (that is, a battery electric vehicle), a hybrid electric vehicle, and the like.

In the present specification, “ECU” is an electronic control device including a microcomputer. The microcomputer includes a CPU (processor), a ROM, a RAM, a non-volatile memory (storage medium) that can write data, an interface, and the like. The ECU is also referred to as a controller or a computer.

A driving assistance ECU 10 executes a roadway deviation prevention control described below. The roadway deviation prevention control may be referred to as an “LDA control”. The driving assistance ECU 10 is connected to components described below, and transmits and receives information or signals to and from the components. The driving assistance ECU 10 may be composed of a plurality of ECUs.

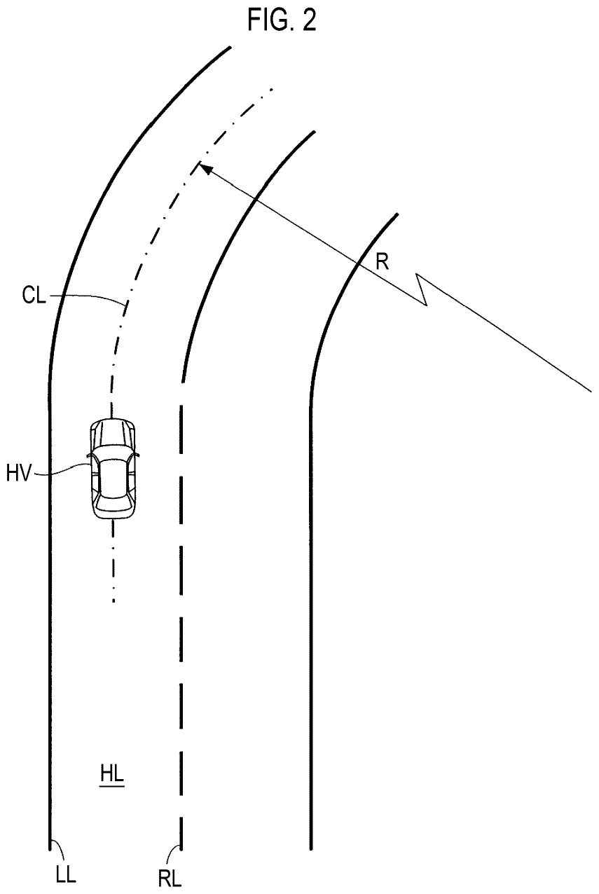

A camera sensor 21 acquires image data by imaging a scene in front of the vehicle HV each time a predetermined time elapses. The driving assistance ECU 10 recognizes a “left boundary line LL” and a “right boundary line RL” on the road based on the image data (see FIG. 2). The boundary line is a lane demarcation line (for example, a white line). A region between the left boundary line LL and the right boundary line RL is a traveling lane HL.

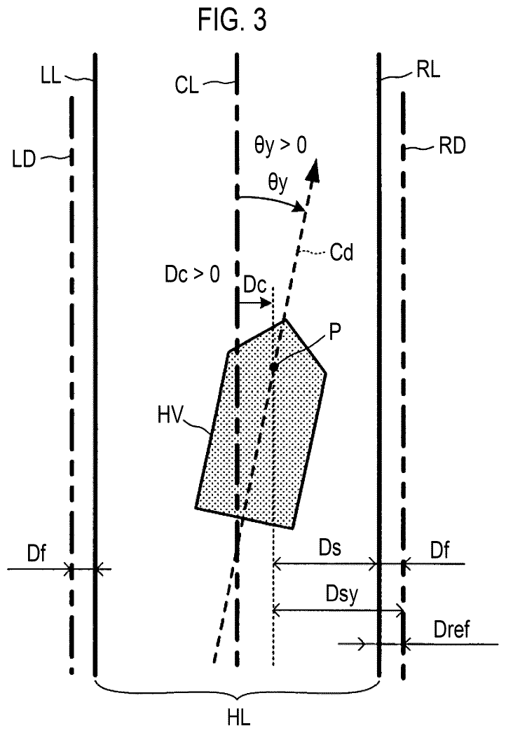

Further, the driving assistance ECU 10 acquires a curvature radius R (see FIG. 2), an approach distance Ds, and a yaw angle θy (see FIG. 3) based on the image data.

The curvature radius R is the radius of curvature of a “line passing through the center between the left boundary line LL and the right boundary line RL (i.e., the center line CL)” at a position forward by a predetermined distance from the vehicle HV.

As shown in FIG. 3, the approach distance Ds is a distance from a reference point P of the vehicle HV to a boundary line on a side where the vehicle HV is about to deviate from the traveling lane HL. The reference point P on the vehicle HV is a center point between a left front wheel and a right front wheel of the vehicle HV. For convenience, a side where the vehicle HV is about to deviate from the traveling lane HL is referred to as a “deviation side”.

The yaw angle θy is an angle between a direction of a center line CL and a front-rear axis direction of the vehicle HV (that is, a traveling direction of the vehicle HV).

Further, the driving assistance ECU 10 obtains a sum of the approach distance Ds and a predetermined correction distance Df as “departure margin distance Dsy (=Ds+Df)”. The correction distance Df may be “0”, a positive value, or a negative value.

A vehicle speed sensor 22 outputs a signal indicating a speed (that is, a vehicle speed) Vh of the vehicle HV.

A yaw rate sensor 23 outputs a signal indicating a yaw rate Yr of the vehicle HV.

A lateral acceleration sensor 24 outputs a signal indicating an acceleration (that is, a lateral acceleration) Gy of the vehicle HV in a vehicle width direction.

A brake switch 25 outputs an on signal in a case where a brake pedal (not shown) of the vehicle HV is operated and a braking force is applied to the vehicle HV by a braking device (not shown), and outputs an off signal in a case where the brake pedal is not operated.

A steering angle sensor 26 outputs a signal indicating a steering angle Sa of the vehicle HV.

A steering torque sensor 27 outputs a signal indicating a steering torque Tq input to a steering shaft (not shown) by an operation of a steering wheel (not shown) of the vehicle HV.

The LDA switch 28 outputs an on signal when the driver of the vehicle HV operates the LDA switch 28 to request execution of roadway deviation prevention control while the LDA switch 28 is generating an off signal. The LDA switch 28 outputs an off signal when the driver of the vehicle HV operates the LDA switch 28 to request termination of the roadway deviation prevention control while the LDA switch 28 is generating an on signal.

A driving mode selection switch 29 is operated by the driver of the vehicle HV. When the driver performs a predetermined operation on the driving mode selection switch 29 in order to set a driving mode of the vehicle HV to a normal mode, the driving mode selection switch 29 outputs a signal indicating that the normal mode is selected. When the driver performs a predetermined operation on the driving mode selection switch 29 in order to set a driving mode of the vehicle HV to a sports mode, the driving mode selection switch 29 outputs a signal indicating that the sports mode is selected.

The driving assistance ECU 10 is connected to a steering motor 30. The steering motor 30 drives a steering mechanism (not shown) of the vehicle HV in response to an instruction from the driving assistance ECU 10 to change a steering angle of the vehicle HV (that is, a steering angle of a turning wheel).

### Outline of Operation

As shown in FIG. 3, the first device DS1 determines a line obtained by moving the left boundary line LL to an outer side (left side) of the traveling lane HL by the correction distance Df as a left deviation regulation line LD. The first device DS1 determines a line obtained by moving the right boundary line RL to an outer side (right side) of the traveling lane HL by the correction distance Df as a right deviation regulation line RD. In a case where it is expected that the vehicle HV deviates from the traveling lane HL through the left deviation regulation line LD, the first device DS1 changes the steering angle of the vehicle HV such that the vehicle HV travels in a right direction. In a case where it is expected that the vehicle HV deviates from the traveling lane HL through the right deviation regulation line RD, the first device DS1 changes the steering angle of the vehicle HV such that the vehicle HV travels in a left direction. The operation of changing the steering angle is an “operation of applying a force for changing a traveling direction of the vehicle HV to the vehicle HV” so that the vehicle HV does not deviate from the traveling lane HL, and is referred to as a “roadway departure avoidance operation”. A start condition of the roadway departure avoidance operation is satisfied in a case where it is expected that the vehicle HV deviates from the traveling lane HL. The control of preventing the vehicle HV from deviating from the traveling lane HL by the roadway departure avoidance operation is referred to as “roadway deviation prevention control”.

Meanwhile, as shown in FIG. 2, when the vehicle HV enters a curved road (curve) from a straight road, the vehicle speed Vh may be higher than the predetermined vehicle speed threshold value Vhth. In this case, there is a high possibility that the vehicle HV deviates from the traveling lane HL due to a strong centrifugal force while the vehicle HV is traveling the entered curved road.

Therefore, in a case where the specific condition is satisfied, the first device DS1 changes the start condition of the roadway departure avoidance operation to a condition that is more easily satisfied than in a case where the specific condition is not satisfied. The specific condition includes, as one of the satisfaction conditions, a first condition that the vehicle speed Vh when the vehicle HV enters the curved road from the straight road is higher than the predetermined vehicle speed threshold value Vhth.

Therefore, with the first device DS1, in a case where the vehicle HV enters the curved road at a high speed and the specific condition is satisfied, the roadway departure avoidance operation is started at a relatively early time point. Therefore, it is possible to reduce the possibility that the vehicle HV deviates from the traveling lane of the curved road. Further, the first device DS1 starts the roadway departure avoidance operation at a normal time point in a case where the specific condition is not satisfied. Therefore, with the first device DS1, in a case where the driver causes the vehicle HV to enter the curved road at an appropriate speed, there is a high possibility that the roadway departure avoidance operation is not started. Therefore, the first device DS1 can reduce the frequency with which the driver finds the roadway departure avoidance operation troublesome.

### Specific Behavior

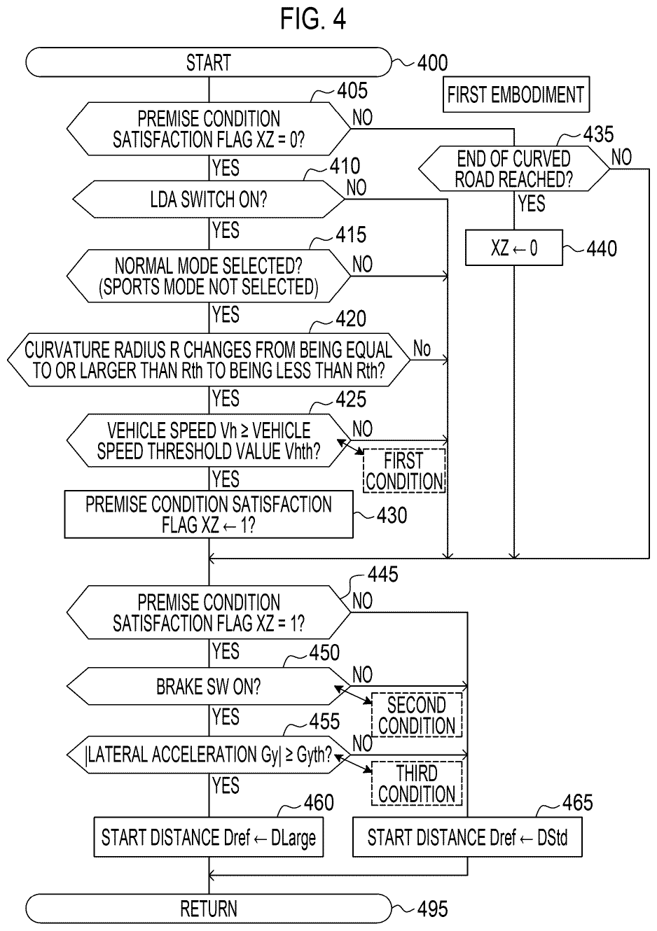

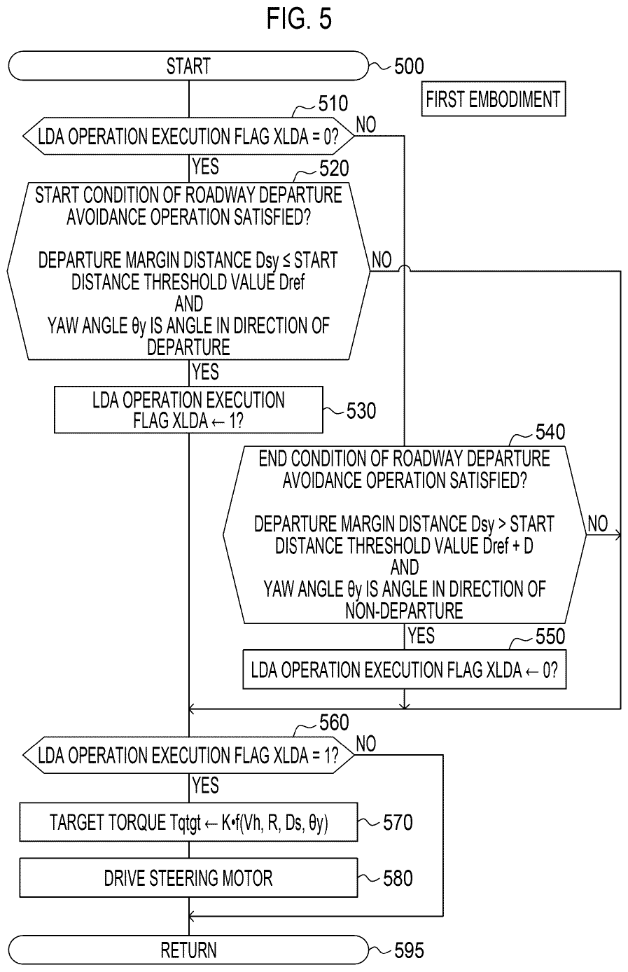

The CPU of the driving assistance ECU 10 executes routines shown in FIGS. 4 and 5 each time a predetermined time elapses. In the following, “step” may be denoted by “S”. A value of each flag described below is set to “O” in an initialization routine (not shown) executed by the CPU when the vehicle HV is started.

At a predetermined timing, the CPU starts processing at S400 of FIG. 4 and proceeds to S405, and determines whether the value of a premise condition satisfaction flag XZ is “0”.

In a case where the value of the premise condition satisfaction flag XZ is “0”, the CPU proceeds from S405 to S410 and determines whether the LDA switch 28 outputs an on signal. That is, the CPU determines whether the driver requests execution of the roadway deviation prevention control.

In a case where the LDA switch 28 outputs an on signal, the CPU proceeds from S410 to S415 and determines whether the normal mode is selected as the driving mode based on an output signal of the driving mode selection switch 29. In other words, the CPU determines whether the driver has selected the sports mode.

In a case where the normal mode is selected as the driving mode, the CPU proceeds from S415 to S420 and determines whether the current time point is “a time point immediately after a time point at which the curvature radius R changes from being equal to or larger than a radius threshold value Rth to being less than the radius threshold value Rth”. That is, the CPU determines at S420 whether the vehicle HV has entered the curved road from the straight road. The radius threshold value Rth is set to a value at which the traveling lane HL can be regarded as a curved road when the curvature radius R is less than the radius threshold value Rth.

In a case where the vehicle HV has entered from the straight road to the curved road, the CPU proceeds from S420 to S425 and determines whether the vehicle speed Vh is equal to or higher than the predetermined vehicle speed threshold value Vhth. The condition that the vehicle speed Vh of the vehicle HV when entering a curved road from a straight road is equal to or higher than the predetermined vehicle speed threshold value Vhth may be referred to as a ‘first condition’ for convenience.

In a case where the vehicle speed Vh is equal to or higher than the predetermined vehicle speed threshold value Vhth, the CPU determines that the premise condition is satisfied, proceeds from S425 to S430, and sets the value of the premise condition satisfaction flag XZ to “1”. Then, the CPU proceeds to S445.

In a case where the CPU determines “No” in any of steps S410 to S425, the CPU proceeds from the step in which “No” is determined to S445. Therefore, in these cases, the value of the premise condition satisfaction flag XZ is maintained at “0”.

On the other hand, when the CPU proceeds to S405 and the value of the premise condition satisfaction flag XZ is “1”, the CPU proceeds from $405 to S435 and determines whether the vehicle HV has entered the straight road from the curved road. In other words, the CPU determines whether the vehicle HV has left the curved road. Specifically, the CPU determines whether the current time point is “a time point immediately after a time point at which the curvature radius R changes from being less than the radius threshold value Rth to being equal to or larger than the radius threshold value Rth”.

In a case where the vehicle HV has not left the curved road, the CPU directly proceeds from S435 to S445. In this case, the value of the premise condition satisfaction flag XZ is maintained at “1”. On the other hand, in a case where the vehicle HV has left the curved road, the CPU proceeds from S435 to S440 and sets the value of the premise condition satisfaction flag XZ to “0”. Then, the CPU proceeds to S445.

At S445, the CPU determines whether the value of the premise condition satisfaction flag XZ is “1”. The value of the premise condition satisfaction flag XZ being “1” means that the vehicle speed Vh of the vehicle HV when entering the curved road is higher than the predetermined vehicle speed threshold value Vhth. In other words, when the value of the premise condition satisfaction flag XZ is “1”, there is a high possibility that the vehicle HV deviates from the traveling lane HL toward the outer side of the curved road in the entered curved road.

In a case where the value of the premise condition satisfaction flag XZ is “1”, the CPU proceeds from S445 to S450 and determines whether a braking force is applied to the vehicle HV by determining whether the brake switch 25 outputs an on signal. That is, at S450, the CPU determines whether the driver of the vehicle HV indicates an intention to decelerate the vehicle HV by performing a braking operation. The condition that is satisfied when the driver of the vehicle HV performs the braking operation may be referred to as a “second condition” for convenience.

In a case where the brake switch 25 outputs an on signal, the CPU proceeds from S450 to S455 and determines whether the magnitude (|Gyl) of the lateral acceleration Gy detected by the lateral acceleration sensor 24 is equal to or higher than a lateral acceleration threshold value Gyth. That is, the CPU determines whether the vehicle VH actually starts moving quickly toward the outer side of the curved road due to centrifugal force. The condition that is satisfied in a case where the magnitude (|Gyl) of the lateral acceleration Gy is equal to or higher than the lateral acceleration threshold value Gyth may be referred to as a “third condition” for convenience.

In a case where the magnitude (|Gy|) of the lateral acceleration Gy is equal to or greater than the lateral acceleration threshold value Gyth, the CPU proceeds from $455 to S460 and sets a start distance threshold value Dref of the roadway departure avoidance operation to a value DLarge that is larger than a standard value DStd. Then, the CPU proceeds to S595 and temporarily ends the present routine.

As will be described later, in a case where the departure margin distance Dsy (=Ds+Df) is equal to or less than the start distance threshold value Dref, the roadway departure avoidance operation (that is, an operation of changing the steering angle of the turning wheel) is started (S520, S530, and S560 to S580 in FIG. 5). Therefore, in a case where the start distance threshold value Dref of the roadway departure avoidance operation is set to the value DLarge, the roadway departure avoidance operation is started at an earlier time point than in a case where the start distance threshold value Dref of the roadway departure avoidance operation is set to the standard value DStd. The process at S460 may be referred to as a “first processing” or a “start condition change process” for changing the start condition to a condition that is more easily satisfied.

On the other hand, in a case where the CPU determines “No” in any of steps S445, S450, and S455, the CPU proceeds from the step in which “No” is determined to S465.

At S465, the CPU sets the start distance threshold value Dref of the roadway departure avoidance operation to the standard value DStd. Then, the CPU proceeds to S495 and temporarily ends the present routine.

At a predetermined timing, the CPU starts processing at S500 of FIG. 5 and proceeds to S510, and determines whether the value of an LDA operation execution flag XLDA is “0”. As will be described later, the value of the LDA operation execution flag XLDA is set to “1” when the start condition of the roadway departure avoidance operation is satisfied, and is set to “0” when the end condition of the roadway departure avoidance operation is satisfied.

In a case where the value of the LDA operation execution flag XLDA is “0”, the CPU proceeds from S510 to S520 and determines whether the start condition of the roadway departure avoidance operation is satisfied. The start condition is satisfied, for example, in a case where both the following condition C1 and condition C2 are satisfied.

### Start Condition of Roadway Departure Avoidance Operation

(Condition C1) The departure margin distance Dsy is equal to or less than the start distance threshold value Dref that is a positive predetermined value.

(Condition C2) The traveling direction of the vehicle HV indicated by the yaw angle θy is a direction toward the deviation regulation line on the deviation side.

The CPU may determine that the start condition of the roadway departure avoidance operation is satisfied in a case where a time (that is, a reaching time) TTD required until the departure margin distance Dsy reaches the start distance threshold value Dref is equal to or less than a reaching time threshold value TTDth. In this case, the CPU calculates the reaching time TTD based on the departure margin distance Dsy at the current time point, a lateral speed Vy at the current time point, the lateral acceleration Gy at the current time point, and the start distance threshold value Dref. The CPU calculates a change amount of the approach distance Ds per unit time as the lateral speed Vy at the current time point.

In a case where the start condition of the roadway departure avoidance operation is satisfied, the CPU proceeds from S520 to S530 and sets the value of the LDA operation execution flag XLDA to “1”. Then, the CPU proceeds to S560 described later. On the other hand, in a case where the start condition of the roadway departure avoidance operation is not satisfied, the CPU directly proceeds from S520 to S560.

In a case where the CPU proceeds to S510 and the value of the LDA operation execution flag XLDA is “1”, the CPU proceeds from S510 to S540 and determines whether the end condition of the roadway departure avoidance operation is satisfied. The end condition of the roadway departure avoidance operation is satisfied, for example, in a case where both the following condition D1 and condition D2 are satisfied.

### End Condition of Roadway Departure Avoidance Operation

(Condition D1) The departure margin distance Dsy is larger than a value obtained by adding a minute positive value d to the start distance threshold value Dref (=Dref+d). The value d may be “0”.

(Condition D2) The traveling direction of the vehicle HV indicated by the yaw angle θy is not a direction toward the deviation regulation line on the deviation side. In other words, the traveling direction of the vehicle HV indicated by the yaw angle θy is a direction toward the deviation regulation line on a side opposite to the deviation regulation line at the time when it is determined that the start condition of the roadway departure avoidance operation is satisfied.

In a case where the end condition of the roadway departure avoidance operation is not satisfied, the CPU directly proceeds from S540 to S560. On the other hand, in a case where the end condition of the roadway departure avoidance operation is satisfied, the CPU proceeds from S540 to S550 and sets the value of the LDA operation execution flag XLDA to “0”. Then, the CPU proceeds to S560 described later.

At S560, the CPU determines whether the value of the LDA operation execution flag XLDA is “1”. In a case where the value of the LDA operation execution flag XLDA is not “1”, the CPU directly proceeds from S560 to S595 and temporarily ends the present routine. In this case, the roadway departure avoidance operation is not executed.

On the other hand, in a case where the value of the LDA operation execution flag XLDA is “1”, the CPU proceeds from S560 to S570 and calculates a target torque Tqtgt as a target steering control amount based on the vehicle speed Vh, the curvature radius R, the approach distance Ds, and the yaw angle θy.

For example, the CPU obtains the target torque Tqtgt in accordance with the following Equation (1).

$$Tqtgt = K \cdot f ( Vh , R , Ds , θ y ) = K \cdot ( K 1 \cdot ( {Vh}^{2} / R ) + K 2 \cdot ( Dref - Dsy ) + K 3 \cdot θ y ) \qquad ( 1 )$$

In Equation (1), K, K1, K2, and K3 are control gains. The gain K is a positive predetermined value, and is “1” in the first embodiment. The control gains K1, K2, and K3 are values in which signs (pluses and minuses) thereof change in accordance with, for example, whether the traveling lane HL is a right curved road, a left curved road, or a straight road. In addition, the control gains K1, K2, and K3 are values in which the signs (pluses and minuses) thereof change in accordance with, for example, whether the deviation regulation line on the deviation side is the left deviation regulation line LD or the right deviation regulation line RD. That is, in a case where a torque equal to the target torque Tqtgt is generated by the steering motor 30, the signs of the control gains K1, K2, and K3 are determined such that the steering angle of the vehicle HV is a value for causing the vehicle HV to travel toward the center line CL.

A function f in Equation (1) may further include a term K4. (Yr*−Yr). Yr* is a target yaw rate, and Yr is an actual yaw rate of the vehicle detected by the yaw rate sensor 23. “Value obtained by subtracting the departure margin distance Dsy from the start distance threshold value Dref (Dref-Dsy)” in Equation (1) may be referred to as a side distance Ds′.

As described above, the target torque Tqtgt is calculated such that the absolute value |Tqtgt| increases as the departure margin distance Dsy decreases (i.e., as the side distance Ds' increases). Further, the target torque Tqtgt is calculated such that the absolute value |Tqtgt| of the target torque Tqtgt increases as the magnitude |0y| of the yaw angle θy increases, in a case where the traveling direction of the vehicle HV indicated by the yaw angle θy is on the deviation side. The calculation method of the target torque Tqtgt is itself well known, and is disclosed in, for example, Japanese Unexamined Patent Application Publication No. 2018-79835 and Japanese Unexamined Patent Application Publication No. 2020-11562.

Next, the CPU proceeds to S580 and drives the steering motor 30 such that the steering motor 30 generates a torque equal to the target torque Tqtgt. Then, the CPU proceeds to S595.

As described above, when the vehicle HV enters the curved road at a vehicle speed Vh equal to or higher than the predetermined vehicle speed threshold value Vhth at which the possibility of deviating from the curved road increases, the first device DS1 starts the roadway departure avoidance operation at an earlier time point. Therefore, the first device DS1 can reduce the possibility that the vehicle HV deviates from the traveling lane HL in the curved road. On the other hand, when the vehicle HV enters the curved road at a ‘vehicle speed Vh less than the threshold vehicle speed Vhth’, the roadway departure avoidance operation is not started early. Therefore, the frequency with which the driver feels the roadway departure avoidance operation as being troublesome is reduced.

### 2. Second Embodiment

A roadway departure avoidance device according to a second embodiment of the present disclosure (hereinafter, referred to as a “second device DS2”) is different from the first device DS1 only in the following points. That is, in a case where the specific condition is satisfied, the second device DS2 increases a magnitude of a steering control amount immediately after the start condition is satisfied, compared to a case where the specific condition is not satisfied, even though a degree of a roadway deviation tendency of the vehicle HV is the same. The steering control amount includes a steering torque or a steering angle for preventing roadway deviation. The degree of the roadway deviation tendency is represented by, for example, a combination of the departure margin distance Dsy and the yaw angle θy, or a combination of the departure margin distance Dsy, the lateral acceleration Gy, and the yaw angle θy.

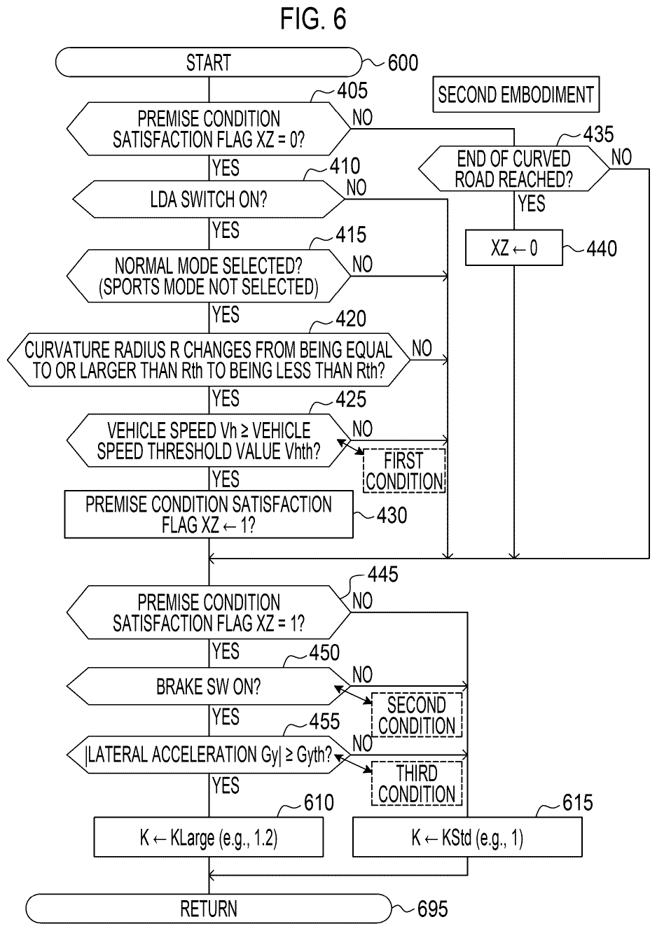

More specifically, the CPU of the driving assistance ECU 10 of the second device DS2 executes the routine shown in FIG. 6 each time a predetermined time clapses instead of the routine shown in FIG. 4. The routine shown in FIG. 6 is different from the routine shown in FIG. 4 only in that S460 and S465 of the routine shown in FIG. 4 are replaced with S610 and S615, respectively. Hereinafter, these difference points will be described.

That is, when the CPU determines ‘Yes’ in all steps from S445 to S455 shown in FIG. 6, the process proceeds to S610, where a value of gain K in Equation (1) is set to a value KLarge. The value KLarge is a value larger than a standard value KStd described below (for example, “1.2” larger than “1”). Then, the CPU proceeds to S695 and temporarily ends the present routine.

On the other hand, in a case where the CPU determines “No” in any of steps S445 to S455 shown in FIG. 6, the CPU proceeds from the step in which “No” is determined to S615. At S615, the CPU sets the value of the gain K in Equation (1) to the standard value KStd (for example, “1”). Then, the CPU proceeds to S695 and temporarily ends the present routine.

As a result, in a case where the specific condition is satisfied, “the magnitude of the target torque Tqtgt immediately after the start condition is satisfied” calculated at step 570 of FIG. 5 is larger than in a case where the specific condition is not satisfied. Therefore, in a case where the specific condition is satisfied, the “force for changing the traveling direction of the vehicle HV” applied to the vehicle HV by the roadway departure avoidance operation at the time point immediately after the start condition is satisfied is larger than in a case where the specific condition is not satisfied. Therefore, the vehicle HV is quickly returned toward the center line CL side. The process of S610 may be referred to as a “second processing” or an “operation enhancement process” for increasing the force for changing the traveling direction of the vehicle HV by the roadway departure avoidance operation immediately after the start condition is satisfied, compared to a case where the specific condition is not satisfied.

The vehicle HV may enter the curved road at a vehicle speed Vh equal to or higher than a threshold vehicle speed Vhth at which the possibility of deviating from the curved road increases. In this case, the second device DS2 executes the roadway departure avoidance operation of applying a larger force to the vehicle HV for changing the traveling direction of the vehicle HV to the center line CL side. Therefore, it is possible to further reduce the possibility that the vehicle HV deviates from the traveling lane HL when traveling on a curved road. On the other hand, when the vehicle HV enters the curved road at a “vehicle speed Vh less than the threshold vehicle speed Vhth”, the normal roadway departure avoidance operation is performed. Therefore, the frequency with which the driver feels the roadway departure avoidance operation as being troublesome is reduced.

The present disclosure is not limited to the above-described embodiments, and various modifications as described below can be employed within the scope of the present disclosure.

For example, although each of the first device DS1 and the second device DS2 performs an operation of changing the steering angle of the turning wheel as the roadway departure avoidance operation, another operation of generating a yaw moment to the vehicle may be performed as the roadway departure avoidance operation. For example, the other operation may be an operation of creating a difference between a driving force of a left drive wheel and a driving force of a right drive wheel, or may be an operation of creating a difference between a braking force applied to the left wheel and a braking force applied to the right wheel.

For example, each of the first device DS1 and the second device DS2 may calculate a target steering angle θtgt instead of the target torque Tqtgt as “target control amount in the roadway deviation prevention control” calculated at S570 of FIG. 5. In this case, each of the first device DS1 and the second device DS2 drives the steering motor 30 such that an actual steering angle is equal to the target steering angle Atgt.

For example, the first device DS1 and the second device DS2 can be used in combination. Further, each of the first device DS1 and the second device DS2 may execute, as the first processing (operation enhancement process), a process of setting the correction distance Df in a case where the specific condition is satisfied to a value smaller than the correction distance Df in a case where the specific condition is not satisfied. Thereby, in a case where the specific condition is satisfied, the start condition of the roadway departure avoidance operation can be satisfied at an earlier time point. Further, since the magnitude of the second term (K2· (Dref-Dsy)) on the right side of Equation (1) can be increased, the force for changing the traveling direction of the vehicle HV immediately after the start condition is satisfied can be further increased.

Each of the first device DS1 and the second device DS2 may omit S415. In this case, in a case where the CPU determines “Yes” at S410, the process proceeds to S420.

At S420, each of the first device DS1 and the second device DS2 may acquire a current position of the vehicle HV and map information from a navigation system (not shown), and determine whether the vehicle HV has entered the curved road from the straight road based on the current position and the map information.

Each of the first device DS1 and the second device DS2 may omit S450. In this case, in a case where the CPU determines “Yes” at S445, the process proceeds from S445 to S455. Further, each of the first device DS1 and the second device DS2 may omit S455. In this case, in a case where the CPU determines “Yes” at S450, the process proceeds from S450 to S460 or S610. Each of the first device DS1 and the second device DS2 may omit both S450 and S455.

For example, each of the first device DS1 and the second device DS2 is applicable to a subject vehicle that is in a state where a driving mode has transitioned from autonomous driving to driver-based driving.

What is claimed is:

1. A roadway departure avoidance device comprising a controller configured to perform, when a start condition that is predetermined is satisfied, the start condition being satisfied in a case where there is a possibility that a vehicle departs from a traveling lane on which the vehicle is traveling, a roadway departure avoidance operation of applying, to the vehicle, a force to change a traveling direction of the vehicle such that the vehicle does not depart from the traveling lane,
wherein the controller is configured to perform, in a case where a specific condition is satisfied, the specific condition including, as one of satisfaction conditions, a first condition in which a vehicle speed when the vehicle enters from a straight road into a curved road is higher than a predetermined vehicle speed threshold value, at least one of first processing of changing the start condition to a condition that is more easily satisfied as compared with a case where the specific condition is not satisfied, and second processing of increasing, at a timing immediately after the start condition is satisfied, the force that is applied to the vehicle through the roadway departure avoidance operation to change the traveling direction of the vehicle, as compared with a case where the specific condition is not satisfied.

2. The roadway departure avoidance device according to claim 1, wherein the controller is configured to determine that the specific condition is satisfied when a second condition is satisfied, the second condition being satisfied in a case where a driver of the vehicle performs a braking operation, after the first condition is satisfied.

3. The roadway departure avoidance device according to claim 1, wherein the controller is configured to determine that the specific condition is satisfied when a third condition is satisfied, the third condition being satisfied in a case where a magnitude of a lateral acceleration of the vehicle is equal to or greater than a predetermined lateral acceleration threshold value, after the first condition is satisfied.

4. A roadway departure avoidance method of performing, when a start condition that is predetermined is satisfied, the start condition being satisfied in a case where there is a possibility that a vehicle departs from a traveling lane on which the vehicle is traveling, a roadway departure avoidance operation of applying, to the vehicle, a force to change a traveling direction of the vehicle such that the vehicle does not depart from the traveling lane, the roadway departure avoidance method comprising:
determining whether a specific condition is satisfied, the specific condition including, as one of satisfaction conditions, a first condition in which a vehicle speed when the vehicle enters from a straight road into a curved road is higher than a predetermined vehicle speed threshold value; and
performing, in a case where a determination is made that the specific condition is satisfied, at least one of first processing of changing the start condition to a condition that is more easily satisfied as compared with a case where the specific condition is not satisfied, and second processing of increasing, at a timing immediately after the start condition is satisfied, the force that is applied to the vehicle through the roadway departure avoidance operation to change the traveling direction of the vehicle, as compared with a case where the specific condition is not satisfied.

5. A non-transitory storage medium storing a program that causes a computer mounted on a vehicle to execute:
performing, when a start condition that is predetermined is satisfied, the start condition being satisfied in a case where there is a possibility that the vehicle departs from a traveling lane on which the vehicle is traveling, a roadway departure avoidance operation of applying, to the vehicle, a force to change a traveling direction of the vehicle such that the vehicle does not depart from the traveling lane;
determining whether a specific condition is satisfied, the specific condition including, as one of satisfaction conditions, a first condition in which a vehicle speed when the vehicle enters from a straight road into a curved road is higher than a predetermined vehicle speed threshold value; and
performing, in a case where a determination is made that the specific condition is satisfied, at least one of first processing of changing the start condition to a condition that is more easily satisfied as compared with a case where the specific condition is not satisfied, and second processing of increasing, at a timing immediately after the start condition is satisfied, the force that is applied to the vehicle through the roadway departure avoidance operation to change the traveling direction of the vehicle, as compared with a case where the specific condition is not satisfied.
